(19) United States
(12) Patent Application Publication
(10) Pub. No.: US 2012/0204746 A1
(43) Pub. Date: Aug. 16, 2012

(54) Multilayer Sheet Material and Method for Making the Same

(76) Inventor: Stefan Füllgraf, Duderstadt (DE)

(21) Appl. No.: 13/409,681

(22) Filed: Mar. 1, 2012

Related U.S. Application Data
(63) Continuation of application No. PCT/EP2010/062020, filed on Aug. 18, 2010.

(30) Foreign Application Priority Data
Sep. 1, 2009 (DE) 10 2009 043 921.8

(51) Int. Cl. B41C 3/00; B05D 3/02; B05D 3/00

(52) U.S. Cl. 101/401.1; 427/256

(57) ABSTRACT

The invention relates to a multilayer sheet material (20) in the form of a printing blanket having a printing layer (21) made of a polymer material, at least one compressible layer (22, 23) and at least one reinforcing base layer (24, 25), the individual layers forming a bond with each other, characterized in that the printing layer (21) has an additional coating (27) locally bounded at at least one location of the printing layer (21) and completely preventing ink transfer at the locally bounded location, wherein the additional coating (27) is built up of at least one resin and/or at least one paint and/or at least one polymer. The invention further relates to a method for making such a multilayer sheet material (20).

### CROSS REFERENCE TO RELATED APPLICATIONS

This application is a continuation application of international patent application PCT/EP 2010/062020, filed Aug. 18, 2010, designating the United States and claiming priority from German application 10 2009 043 921.8, filed Sep. 1, 2009, and the entire content of both applications is incorporated herein by reference.

### FIELD OF THE INVENTION

The disclosure relates to a multilayer sheet-like structure in the form of a printing blanket with a printing layer made of a polymeric material, at least one compressible layer, and at least one reinforcement layer, where the individual layers together form a bonded composite. The disclosure further relates to a process for producing the same.

### BACKGROUND OF THE INVENTION

Multilayer sheet-like structures, in particular printing blankets, are known in the prior art inter alia from the following publications: DE 200 07 227 U1; U.S. Pat. No. 4,812,357; DE 10 2004 023 316 A1; EP 1 504 921 A2; , WO 91/11330 A1.

Modern printing machines transfer the printing ink from a printing cylinder to sheets or webs of the print feedstock. This transfer takes place by way of example in the offset printing process by way of a printing blanket which applies pressure in order to apply the ink from the printing plate by way of the printing blanket onto the medium to be printed. The ink is transferred to the printing blanket by way of those regions of the printing plate that are receptive to ink. No ink transfer takes place in the water-bearing regions of the printing plate. So that the printing plate can be fixed within a modern printing machine, it has to be subjected to bending in the region where it is clamped. In particular in the case of printing plates provided with a coating, the bending damages the surface coating, and this leads to unintended ink transfer from the printing plate to the printing blanket in the affected region. The final result of the cracks that form is that ink marks appear on the print feedstock. Accumulation of ink moreover occurs on the printing layer, and this can lead to irreversible damage to the printing layer or to the entire printing blanket and/or the entire printing plate. This effect is particularly critical in waterless offset printing, where the coating covers the printing layer entirely, i.e., over the entire surface. In this case, the coating is subject to damage which constantly increases and spreads, and is accompanied by major printout problems.

### SUMMARY OF THE INVENTION

In view of the foregoing, it is an object of the present disclosure to provide a multilayer sheet-like structure in the form of a printing blanket which features good resistance to cracking at the locations of the printing layer that in particular result from the clamping of the printing blanket and that are subject to severe mechanical stress, thus avoiding any additional undesired ink transfer at the locations. The multilayer sheet-like structure in the form of a printing blanket is also intended to ensure that no ink transfer takes place from the printing plate to the printing blanket at the locations at which the printing plate has been damaged, thus solving the abovementioned problems.

The object is achieved by providing a multilayer sheet-like structure in the form of a printing blanket with a printing layer made of a polymeric material, at least one compressible layer, and at least one reinforcement layer, where the individual layers together form a bonded composite, where a feature of the sheet-like structure is that the printing layer has been provided in locally restricted manner, at at least one location of the printing layer, with an additional coating which completely prevents ink transfer at the locally restricted location, where the additional coating is composed of at least one resin and/or of at least one lacquer and/or of at least one polymer.

Surprisingly, it has been found that this type of additional coating on a multilayer sheet-like structure in the form of a printing blanket can prevent or markedly reduce the extent of cracking at those locations that are subject to severe mechanical stress, thus preventing undesired ink transfer. Ink transfer from the printing plate to the printing blanket at the damaged locations of the printing plate is equally prevented. No ink transfer from the printing plate to the printing blanket therefore takes place, and this also means that no ink transfer takes place from the printing blanket to the medium to be printed.

It is essential to the disclosure that the additional coating on the surface of the printing layer of the printing blanket is a locally restricted coating and never covers the surface completely because otherwise no ink at all is transferred, and the purposes of the present disclosure are then not served.

The disclosure can also be utilized for complying with customers' wishes relating to avoidance of ink transfer at locations including those which are subject to no, or only very slight, mechanical stress. In this case it is also possible to omit the use of printing plates and to control ink transfer to the print medium entirely by way of the additional locally restricted coating on the printing blanket.

The multilayer sheet-like structure is advantageously used in the offset printing process, preferably in the waterless offset printing process.

The additional locally restricted coating is composed of at least one resin or at least one lacquer, for example based on polyurethanes and/or polyisocyanates, or of at least one polymer. It is also conceivable that combinations of the materials mentioned are used.

The additional locally restricted coating is advantageously composed of at least one polymer. It has proven advantageous to use silicone polymers and/or fluoropolymers, without blending or else in a blend.

The silicone polymer used can comprise, individually or in combination, i.e., in at least two-component systems, any of the silicone polymers known to the person skilled in the art, for example MQ (methyl silicone rubber) MFQ (methyl silicone rubber having fluoro groups, also termed FMQ), MPQ (methyl silicone rubber having phenyl groups, also termed PMQ), MVQ (methyl silicone rubber having vinyl groups, also termed VMQ), MPVQ (methyl silicone rubber having phenyl and vinyl groups, also termed PVMQ), and nitrile silicone rubber, or fluorosilicone.

The fluoropolymer used can comprise, individually or in combination, any of the fluoropolymers known to the person skilled in the art, for example polytetrafluoroethylene (PTFE), modified polytetrafluoroethylene (TFM), fluoroethylene polymer (FEP), perfluorinated alkyl vinyl ether-tetraethylene copolymer (PFA), ethylene-tetrafluoroethylene copolymer (ETFE), polyvinyl fluoride (PVF), polyvinylidene fluoride (PVDF), or ultrahigh-molecular-weight polyethylene (UHMWPE), particular preference being given here to polytetrafluoroethylene (PTFE) or modified polytetrafluoroethylene (TFM).

It is possible to combine silicone polymer and fluoropolymer.

However, the additional locally restricted coating can also involve a polymeric coating based on polyvinyl chloride (PVC), based on synthetic or natural polyisoprene, or based on polyurethanes (PU).

It is advantageous that the additional locally restricted coating penetrates into the printing layer located directly thereunder, the depth to which it penetrates preferably being at most ⅕, particularly preferably at most 1/10, of the thickness of the printing layer.

The reinforcement layer used can comprise a textile structure, for example a woven material, or a foil, such as a polymer foil (e.g. polyamide foil) or metal foil. In the case of a sheet-like structure with many layers and at least two reinforcement layers, it is also possible to use a combination of a textile structure with a foil or with a foil composite. The U.S. Pat. No. 6,019,042 describes a six-layer sheet-like structure with three textile layers and a foil layer (polymer foil or metal foil).

The advantages mentioned are particularly apparent when at least one reinforcement layer is composed of at least one metal or one metal-plastics composite, another term used being metal laminate or metal-based laminate. This applies in particular to multilayer sheet-like structures which have more than one reinforcement sublayer.

If there is only one reinforcement sublayer, this is advantageously composed of at least one metal or one metal-plastics composite, another term used being metal laminate or metal-based laminate.

Another term that is frequently and very generally used for this by persons skilled in the art is metal-based, for example in the expression metal-based printing blanket or metalback blanket (MBB).

It is preferable that the undermost reinforcement layer is always metal-based.

The metal used can also comprise any of the known metals and alloys of these, or composite materials based on at least one metal. However, it is advantageous to use iron or steel, in particular high-specification steel, aluminum, or an aluminum alloy.

When what is known as a metal-based multilayer sheet-like structure is used in the present disclosure a further advantage in that when the additional locally restricted coating is applied at the locations of transition between the metal-based reinforcement layer, which has a protruding part, and the other layers, it ensures improved abrasion resistance. This means that the location of the additional locally restricted coating in this case is as follows: a portion is on the printing layer, a portion is at the margins of the other layers, and a portion is on the surface of the protruding part of the metal-based reinforcement.

These locations of transition are generally the positions where the printing blanket is directly clamped into the printing cylinder. Undesired ink transfer occurs here not only by virtue of cracking of the printing blanket or by virtue of cracking of the printing plate alone but also to an increased extent by virtue of mechanical abrasion of the printing layer of the printing blanket and possibly also of the layers situated thereunder. Locally restricted coating of the printing blanket in this critical region can therefore improve the running performance of the printing blanket.

In most cases, the printing machines have automatic application-pressure-controlled washing equipment, and a coating can therefore also improve cleaning performance, in that the additional locally restricted coating permits easier cleaning of the residual clamping channel of the printing-blanket cylinder, and this in turn leads to lower dynamic forces relating to the rubber edge on the printing blanket.

It has moreover proven advantageous for the polymeric material of the printing layer to be a vulcanizate.

Vulcanizate is the term for products or product components—in this case the printing layer—produced via vulcanization of a vulcanizable polymer mixture. The polymer mixture here comprises one or more rubber components. A vulcanizate features elastic properties. The material used for the crosslinking process depends on the type of rubber used and can be sulfur (e.g. in the case of NR) or peroxides (e.g. in the case of EPDM). Thermal vulcanization at temperatures of from 130 to 200° C. is particularly important. It is also possible to use cold vulcanization or radiation vulcanization.

With regard to the vulcanizate, the following two variants are in particular used:

### Variant A

The vulcanizate is a vulcanized thermoplastic-free rubber mixture comprising at least one rubber component, and also mixture ingredients. Particular rubber components that may be mentioned, but without restriction to these, are:

ethylene-propylene rubber (EPM)

ethylene-propylene diene rubber (EPDM)

nitrile rubber (NBR)

(partially) hydrogenated nitrile rubber (HNBR)

fluoro rubber (FKM)

chloroprene rubber (CR)

natural rubber (NR)

styrene-butadiene rubber (SBR)

isoprene rubber (IR)

butyl rubber (IIR)

bromobutyl rubber (BIIR)

chlorobutyl rubber (CIIR)

butadiene rubber (BR)

chlorinated polyethylene (CM)

chlorosulfonated polyethylene (CSM)

polyepichlorohydrin (ECO)

ethylene-vinyl acetate rubber (EVA)

acrylate rubber (ACM)

ethylene-acrylate rubber (AEM)

The abovementioned types of rubber can be used without blending. It is also possible to use a blend, in particular in conjunction with one of the abovementioned types of rubber, for example an NR/BR blend or a BR/SBR blend.

The following are of particular importance: EPM, EPDM, SBR, BR, CR, NR, HNBR, and NBR. The usual mixture ingredients encompass at least one crosslinking agent or one crosslinking agent system (crosslinking agent and accelerator). Other mixture ingredients are mostly also a filler and/or a processing aid and/or a plasticizer and/or an antioxidant, and also optionally other additives (e.g. ink pigments). In this connection, reference is made to the general prior art in rubber mixture technology.

### Variant B

The vulcanizate is a thermoplastic vulcanizate comprising at least one thermoplastic component, at least one rubber component, which has at least been partially crosslinked, and also mixture ingredients.

The preferred thermoplastic components are polyethylene (PE), polypropylene (PP), polystyrene, polyamide (PA), and polyester (PES).

Particular rubber components that may be mentioned are EPM, EPDM, SBR, BR, CR, NR, HNBR, and NBR, in particular without blending.

With regard to the mixture ingredients, reference is made to the abovementioned mixture technology, in particular to the teaching of U.S. Pat. No. 6,774,162.

Variant A has proven to be particularly advantageous here.

Another object of the present disclosure is to provide a process which can produce a multilayer sheet-like structure in the form of a printing blanket, and which gives the printing blanket good resistance to cracking at the locations of the printing layer that result from the clamping process and that are subject to severe mechanical stress, and which avoids any additional undesired ink transfer at the locations. The process is moreover intended to provide a multilayer sheet-like structure in the form of a printing blanket which prevents ink transfer from the printing plate to the printing blanket at the locations at which the printing plate has been damaged.

This object is achieved via a process for producing a multilayer sheet-like structure in the form of a printing blanket with a printing layer made of a polymeric material, at least one compressible layer, and at least one reinforcement layer, where the individual layers together form a bonded composite, where a feature of the process is that a locally restricted additional coating is applied to the printing layer of a multilayer sheet-like structure, and then the locally restricted additional coating is dried.

It is preferable that the additional locally restricted coating applied for the purposes of the process of the disclosure involves a coating made of at least one silicone polymer and/or of at least one fluoropolymer. The additional locally restricted coating penetrates into the printing layer located directly thereunder. With regard to other materials for the additional locally restricted coating and penetration depth thereof, reference is made here to the descriptions above. With respect to the further structure of the multilayer sheet-like structure and to the materials of the individual layers, reference is similarly made to the descriptions already given above.

For the purposes of the process, it appears to be advantageous for at least one reinforcement layer of the multilayer sheet-like structure to be a metal or a metal-plastics composite, i.e., for a metal-based printing blanket as already described above to be involved.

It is advantageous to apply the additional locally restricted layer by means of spreading or spraying. Any conceivable aids can be used for this purpose, examples being brushes, doctor blades, plasma, etc.

The drying preferably takes place at room temperature in air until drying is complete, and the drying time here depends, of course, on the constitution of the locally restricted additional coating.

However, it is also possible to use, for example, drying ovens and autoclaves.

If the printing layer is composed of a vulcanizable polymeric material, it has proven advantageous for this material to have already been completely or to some extent vulcanized prior to application of the additional locally restricted coating.

### BRIEF DESCRIPTION OF THE DRAWINGS

The invention will now be described with reference to the drawings wherein:

FIG. 1 shows a cross section of a five-layer sheet-like structure with a printing layer made of a vulcanizate and an additional locally restricted coating applied on the printing layer, and an undermost reinforcement layer with protruding part;

FIG. 2 shows a cross section of a three-layer sheet-like structure with a printing layer made of a vulcanizate and an additional locally restricted coating applied on the printing layer;

FIG. 3 shows a cross section of a five-layer sheet-like structure with a printing layer made of a vulcanizate and an additional locally restricted coating applied on the printing layer;

FIG. 4 shows a cross section of a five-layer sheet-like structure with a printing layer made of a vulcanizate and a lower reinforcement layer with protruding part and an additional locally restricted coating applied respectively on the printing layer and on the transition zone between printing layer and undermost reinforcement layer; and,

FIG. 5 is a diagram of ink transfer by means of printing blanket and printing plate.

### DESCRIPTION OF THE PREFERRED EMBODIMENTS OF THE INVENTION

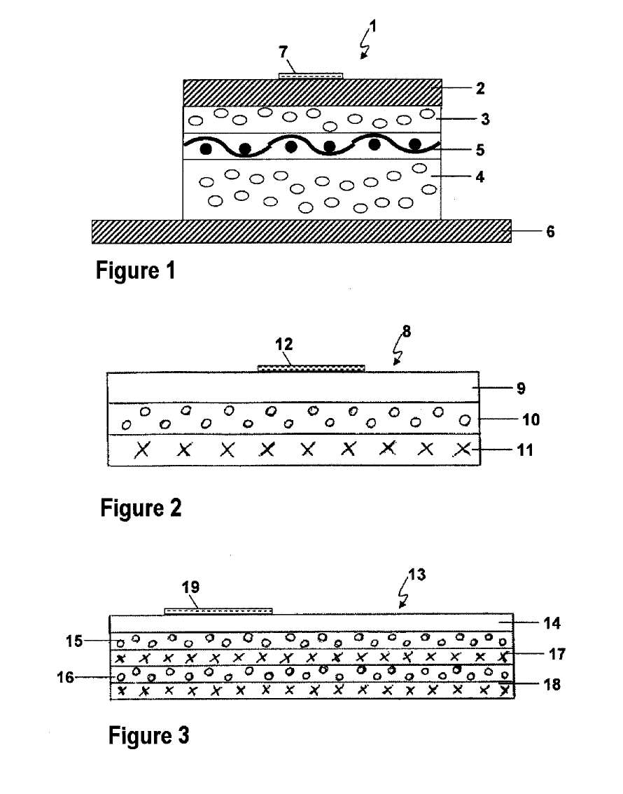

FIG. 1 shows a five-layer sheet-like structure 1 with the following layer sequence:
printing layer 2 by way of example made of a vulcanizate;
first compressible layer 3, by way of example in the form of expanding material of a rubber mixture;
first reinforcement layer 5, for example made of a woven material;
second compressible layer 4, for example in turn taking the form of plastics microbeads in a rubber mixture;
second reinforcement layer 6, by way of example made of metal or metal-plastics composite.

The second and at the same time undermost reinforcement layer 6 has a protruding part which is advantageous when the sheet-like structure is clamped onto a printing roll. There is an additional locally restricted coating 19 lying directly on the printing layer 14 and by way of example made of a two-component silicone rubber.

FIG. 2 shows a three-layer sheet-like structure 8 in the form of a printing blanket with a printing layer 9 by way of example made of a vulcanizate, by way of example based on EPDM, where the printing layer lies directly on a compressible layer 10. The compressible layer then in turn has direct contact with a reinforcement layer 11, for example made of a woven material or metal. There is an additional locally restricted coating 12 lying directly on the printing layer 9 and by way of example made of a polymer.

FIG. 3 shows a five-layer sheet-like structure 13 with the following layer sequence:
printing layer 14 by way of example made of a vulcanizate;
first compressible layer 15, by way of example in the form of plastics microbeads in a rubber mixture;
first reinforcement layer 17, for example made of a woven material;
second compressible layer 16, by way of example in the form of expanding material of a rubber mixture;
second reinforcement layer 18, by way of example in turn made of a woven material or metal or metal-plastics composite.

In the case of a sheet-like structure of FIG. 3, it is possible to use different reinforcement layers in that by way of example the first reinforcement layer is composed of a woven material and the second reinforcement layer is composed of a foil, for example of a polymer foil (e.g. polyamide foil), or of a metal foil, or of a foil composite, by way of example in the form of a polyamide-polyester foil composite.

There is an additional locally restricted coating 19 lying directly on the printing layer 14 and by way of example made of a two-component silicone rubber.

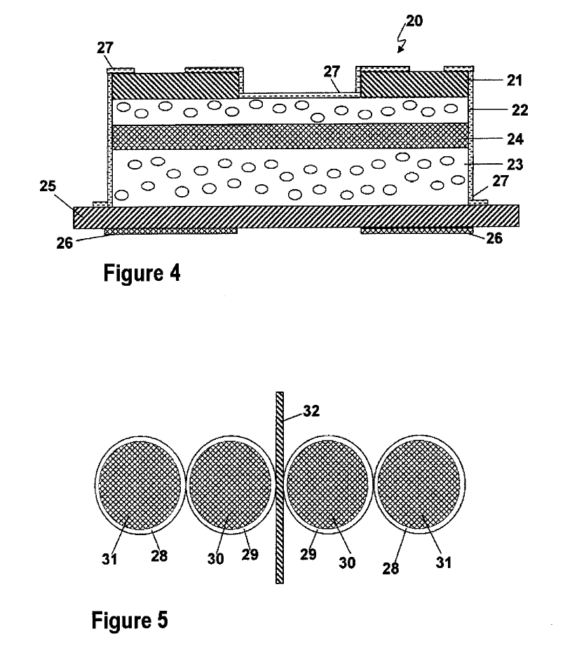

FIG. 4 shows a five-layer sheet-like structure 20 with the following layer sequence:
printing layer 21 by way of example made of a vulcanizate;
first compressible layer 22;
first reinforcement layer 24, by way of example made of a woven material;
second compressible layer 23, by way of example in the form of plastics microbeads in a rubber mixture or foamed plastics foil;
second reinforcement layer 25, by way of example made of metal or metal-plastics composite.

The second and at the same time undermost reinforcement layer 6 has a protruding part which is advantageous when the sheet-like structure is clamped onto a printing roll. The undermost reinforcement layer 6 moreover has a protective foil 26, which serves as corrosion protection for the printing cylinder. The extent to which the protective foil 26 covers the underside of the undermost reinforcement layer, i.e., the side that has no contact with the other layers of the sheet-like structure, can be complete or partial.

There is an additional locally restricted coating 19 lying directly on the printing layer 14 and by way of example made of Teflon. On the transition zone between printing layer 21 and undermost reinforcement layer 26 there is another additional locally restricted coating 19 made of an identical or different material. Additional cutouts or depressions in the printing layer 21 and/or in the protective foil 26, where these are as shown in FIG. 4, are advantageous because they eliminate pressure or reduce pressure at this location and promote the favorable effects of the present disclosure. The cutouts and/or incisions can result from mechanical processes, for example via scribing, cutting, or pressure, or from chemical processes, for example via etching, or else via irradiation. In FIG. 4, by virtue of the cutouts and/or incisions described, a portion of the additional locally restricted coating 19 is then to some extent not in direct contact with the printing layer 21. However, it is also possible that, by example by virtue of pressure, the cutouts and/or incisions merely reduce the thickness of the printing layer 21. In this case, the additional locally restricted coating 19 again has complete contact with the printing layer 21 at the location.

FIG. 5 is a diagram of ink transfer by means of printing plates 28 and printing blanket 29. The printing plates 28 and the printing blankets 29 have respectively been applied on a printing cylinder (30, 31). The printing plate applies the ink to the printing blanket, which then in turn passes the ink onto the medium 32 to be printed. The intention here is to clarify once again the difference between printing plate and printing blanket.

It is understood that the foregoing description is that of the preferred embodiments of the invention and that various changes and modifications may be made thereto without departing from the spirit and scope of the invention as defined in the appended claims.

### LEGEND

### (Part of Description)

1 Multilayer sheet-like structure (printing blanket)
2 Printing layer
3 First compressible layer
4 Second compressible layer
5 First reinforcement layer
6 Second reinforcement layer (metal)
7 Locally restricted coating
8 Multilayer sheet-like structure (printing blanket)
9 Printing layer
10 Compressible layer
11 Reinforcement layer
12 Locally restricted coating
13 Multilayer sheet-like structure (printing blanket)
14 Printing layer
15 First compressible layer
16 Second compressible layer
17 First reinforcement layer
18 Second reinforcement layer
19 Locally restricted coating
20 Multilayer sheet-like structure (printing blanket)
21 Printing layer
22 First compressible layer
23 Second compressible layer
24 First reinforcement layer
25 Second reinforcement layer (metal)
26 Protective foil for second reinforcement layer
27 Locally restricted coating
28 Printing plate
29 Printing blanket
30 Printing cylinder for printing blanket
31 Printing cylinder for printing plate
32 Medium to be printed

What is claimed is:

1. A multilayer sheet-like structure in the form of a printing blanket comprising:
a printing layer made of a polymeric material,
at least one compressible layer, and
at least one reinforcement layer,
wherein the individual layers together form a bonded composite,
wherein the printing layer has been provided, at at least one locally restricted location of the printing layer, with an additional coating, which completely prevents ink transfer at the locally restricted location, and
wherein the additional coating is composed of at least one resin and/or of at least one lacquer and/or of at least one polymer.

2. The multilayer sheet-like structure as claimed in claim 1, wherein the multilayer sheet-like structure is used for offset printing.

3. The multilayer sheet-like structure as claimed in claim 1, wherein the locally restricted additional coating is composed of at least one polymer.

4. The multilayer sheet-like structure as claimed in claim 1, wherein the locally restricted additional coating is composed of at least one silicone polymer, of at least one fluoropolymer, or of at least one silicone polymer and of at least one fluoropolymer.

5. The multilayer sheet-like structure as claimed in claim 1, wherein if a single reinforcement layer is present the reinforcement layer is composed of at least one metal or one metal-plastics composite.

6. The multilayer sheet-like structure as claimed in claim 1, wherein if a plurality of reinforcement layers are present at least one reinforcement layer is composed of at least one metal or one metal-plastics composite.

7. The multilayer sheet-like structure as claimed in claim 6, wherein at least the undermost reinforcement layer is composed of a metal or of a metal-plastics composite.

8. The multilayer sheet-like structure as claimed in claim 5, wherein the metal of the reinforcement layer is selected from the group consisting of iron, steel, high-specification steel, aluminum, and an aluminum alloy.

9. The multilayer sheet-like structure as claimed in claim 1, wherein the polymeric material of the printing layer is a vulcanizate.

10. The multilayer sheet-like structure as claimed in claim 9, wherein the vulcanizate is a vulcanized thermoplastic-free rubber mixture comprising at least one rubber component, and also mixture ingredients.

11. The multilayer sheet-like structure as claimed in claim 10, wherein the rubber component is selected from the group consisting of ethylene-propylene rubber (EPM), ethylene-propylene-diene rubber (EPDM), nitrile rubber (NBR), (partially) hydrogenated nitrile rubber (HNBR), chloroprene rubber (CR), natural rubber (NR), styrene-butadiene rubber (SBR), isoprene rubber (IR), butyl rubber (IIR), bromobutyl rubber (BIIR), chlorobutyl rubber (CIIR), butadiene rubber (BR), chlorinated polyethylene (CM), chlorosulfonated polyethylene (CSM), polyepichlorohydrin (ECO), ethylene-vinyl acetate rubber (EVA), acrylate rubber (ACM), and ethylene-acrylate rubber (AEM), or a blend thereof.

12. The multilayer sheet-like structure as claimed in claim 11, wherein the rubber component is selected from the group consisting of EPM, EPDM, SBR, BR, CR, NR, HNBR, and NBR.

13. The multilayer sheet-like structure as claimed in claim 9, wherein the vulcanizate is a thermoplastic vulcanizate comprising at least one thermoplastic component, at least one rubber component, which has been at least partially crosslinked, and also mixture ingredients.

14. The multilayer sheet-like structure as claimed in claim 13, wherein the thermoplastic component is selected from the group consisting of polyethylene (PE), polypropylene (PP), polystyrene (PS), polyamide (PA), and polyester (PES).

15. The multilayer sheet-like structure as claimed in claim 13, wherein the rubber component is selected from the group consisting of EPM, EPDM, SBR, BR, CR, NR, HNBR, and NBR.

16. The multilayer sheet-like structure as claimed in claim 1, wherein the locally restricted additional coating penetrates into the printing layer.

17. The multilayer sheet-like structure as claimed in claim 16, wherein a depth to which the locally restricted additional coating penetrates into the printing layer is at most ⅕ of the thickness of the printing layer.

18. The multilayer sheet-like structure as claimed in claim 17, wherein a depth to which the locally restricted additional coating penetrates into the printing layer is at most 1/10 of the thickness of the printing layer.

19. A process for producing a multilayer sheet-like structure in the form of a printing blanket comprising a printing layer made of a polymeric material, at least one compressible layer, and at least one reinforcement layer, wherein the individual layers together form a bonded composite, the process comprising:
applying a locally restricted additional coating to the printing layer of the multilayer sheet-like structure, and
drying the locally restricted additional coating.

20. The process as claimed in claim 19, wherein the locally restricted additional coating is composed of at least one silicone polymer and/or of at least one fluoropolymer.

21. The process as claimed in claim 18, wherein the locally restricted additional coating penetrates into the printing layer.

22. The process as claimed in claim 19, further comprising applying the locally restricted additional coating via spreading or spraying.

23. The process as claimed in claim 19, wherein the drying of the locally restricted additional coating takes place at room temperature in air.

24. The process as claimed in claim 19, further comprising partially or completely vulcanizing the polymeric material prior to the applying of the locally restricted additional coating if the polymeric material is a vulcanizable polymeric material.

25. The process as claimed in claim 19, wherein the at least one reinforcement layer of the multilayer sheet-like structure is a metal or a metal-plastics composite.
